(19) United States
(12) Patent Application Publication
(10) Pub. No.: US 2011/0270652 A1
(43) Pub. Date: Nov. 3, 2011

(54) CUSTOMER REWARD SYSTEM FOR PROVIDING MULTIPLE REWARD TYPES INCLUDING MOBILE/WIRELESS DEVICE REWARDS

(76) Inventors: Paul McAleese, Cincinnati, OH (US); Robert E. Carmack, Cold Spring, KY (US); Cletus M. Turner, California, KY (US)

(21) Appl. No.: 12/769,997

(22) Filed: Apr. 29, 2010

(51) Int. Cl. G06Q 30/00

(52) U.S. Cl. 705/14.1

(57) ABSTRACT

A customer reward method involves monitoring customer in-store purchases utilizing an in-store point-of-sale computer system and awarding customer points based upon such in-store purchases; storing both (i) cumulative customer point data and (ii) customer point transaction data in a customer database, the customer point transaction data including transaction date and time data; accessing the cumulative customer point data to determine a first customer reward applicable to purchase of a specific product, the first customer reward triggered by identification of the customer's intent to purchase the specific product; and periodically transferring new customer point transaction data to a third party computer system for use by the third party computer system in identifying a second customer reward applicable to use of a customer mobile phone, such that customer points earned by the customer for in-store purchases are used to define two distinct reward types for the customer.

### TECHNICAL FIELD

This application relates generally to systems and methods for providing customer rewards based upon customer purchases and, more particularly, to a customer reward method and system for providing a customer with multiple, distinct reward types based upon the same customer purchasing data.

### BACKGROUND

Customer reward systems have been used in the business environment for many years, including customer reward systems in the form of point-based systems. For example, in the retail environment it is known to provide customers with points based upon customer purchase of items in the store. In the past, these customer reward systems have enabled customers to redeem points for a single reward type such as a store voucher or, in some cases, a fuel discount. However, customers are desirous of achieving the most benefit possible in any give circumstance.

Accordingly, it would be desirable and advantageous to provide a system and method that provides a customer with more than one reward based upon customer purchasing habits in, for example a retail store, provided the customer also participates as a customer of another entity such as a mobile device service provider. In this manner, two distinct entity-customer relationships are established and the customer can received a benefit from both entities based upon its transactions with only one of the entities.

### SUMMARY

In one aspect, a method for providing retail customers with multiple reward types based upon in-store purchases involves: monitoring customer in-store purchases utilizing an in-store point-of-sale computer system and awarding customer points based upon such in-store purchases; storing both (i) cumulative customer point data and (ii) customer point transaction data in a customer database, the customer point transaction data including transaction date and time data; accessing the cumulative customer point data to determine a first customer reward applicable to purchase of a specific product, the first customer reward triggered by identification of the customer's intent to purchase the specific product; and periodically transferring new customer point transaction data to a third party computer system for use by the third party computer system in identifying a second customer reward applicable to use of a customer mobile phone, such that customer points earned by the customer for in-store purchases are used to define two distinct reward types for the customer.

In another aspect, a method for providing retail customers with a mobile device reward based upon customer purchases made in one or more retail stores involves: receiving in a computer system customer transaction data indicative of points earned by a customer through purchasing activity in one or more retail stores; via the computer system, tracking customer point data for the customer, identifying when point data for the customer reaches a specified incremental point level and in response to point data for the customer reaching the specified incremental point level: (i) if the customer has a first mobile plan type, the computer system provides the second reward to the customer as a defined amount of mobile phone usage time; or (ii) if the customer has a second mobile plan type, the computer system provides the second reward to the customer as a defined mobile phone service fee reduction.

### BRIEF DESCRIPTION OF THE DRAWINGS

FIG. 1 shows one embodiment a computer architecture useful in carrying out the present invention.

### DETAILED DESCRIPTION

As used herein, an enterprise comprises a number of stores that may be grouped by geographical or corporate characteristics, such as divisions. Divisions may be defined by geographical location, type of store, e.g. a convenience store or a superstore, or demographics, e.g. rural, urban or suburban. In addition, the demographic profiles of store customers may be used to group stores (e.g. a suburban middle class neighborhood or a suburban upper income neighborhood). As used herein, a store can be a retail outlet, wholesale outlet, restaurant, branch office or other physical location where transactions involving goods or services occur between the customer and the enterprise. Examples of departments for a typical large retail store or what is generally called a superstore may include a men's clothing department, women's clothing department, toy department, consumer electronics department, grocery department, sporting goods department, automotive department, pharmacy department, furniture department, shoe department, alcoholic beverages department, house wares department, baby department and the like. Examples of departments within a typical grocery store can include the meat department, pharmacy department, grocery department, produce department, frozen foods department and the like.

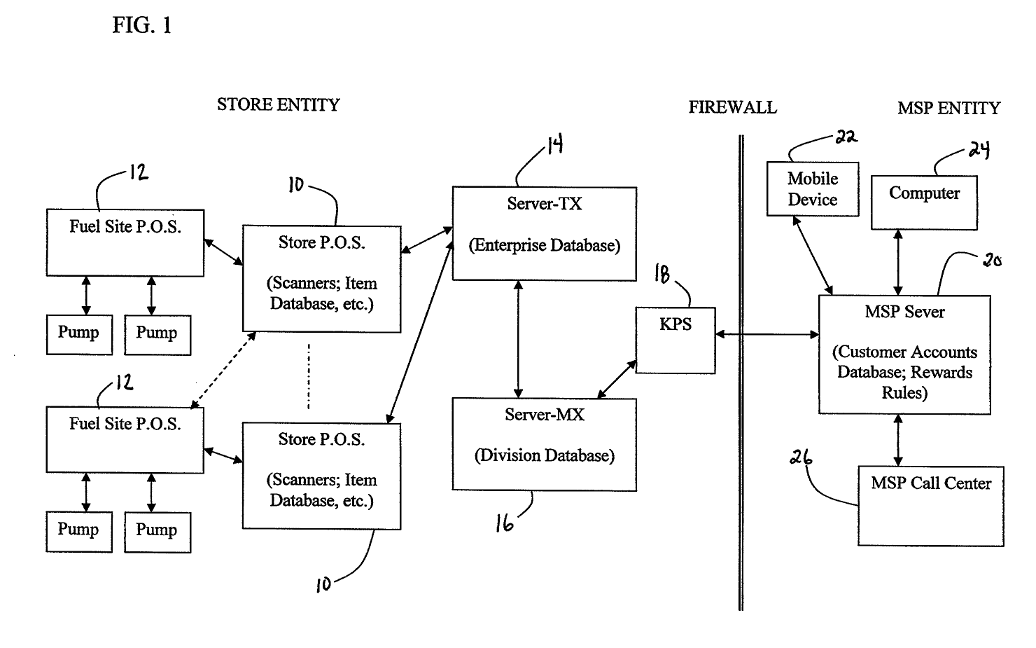

Referring to FIG. 1, one embodiment of a computer architecture for implementing rewards in accordance with the invention is shown. Customer rewards may be driven primarily by customer purchases that are initially tracked at one or more store point-of-sale computer systems 10. Each store may have its own point-of-sale computer system 10 that is associated with, for example, multiple checkout stations having scanners (e.g., bar code scanners) for scanning product codes of items being purchased. The checkout stations may be manned by customer personnel or, in the case of self-service checkout stations, unmanned. Each store point-of-sale computer system typically includes an associated item database that is accessed to retrieve, among other information, item identity and cost information for items that are scanned during checkout. The checkout scanners are also used to scan a customer identifying card, such as a loyalty or shopper card, so that customer purchases can be tracked for the purpose of providing customer rewards. Alternative means may be used to identify the customer, such as customer entry of an alternate-id via a keypad, or customer swiping of a card with magnetic stripe, such as a shopper card or credit or debit card. The invention defined herein is not to be limited by the manner of customer identification at the point-of-sale.

As shown, each store point-of-sale may be linked for communication with a fuel site point-of-sale 12 for the purpose of facilitating and tracking customer fuel purchases and providing fuel rewards to customers, such as discounts on the price-per-gallon of gas. In this regard, the fuel site associated with each store point-of-sale may typically be a fuel site/station adjacent to, or on the same property as the retail store. For example, grocery, supermarket and club stores commonly have an on-site fuel station adjacent the store parking lot. However, it is recognized that any given store point-of-sale computer system 10 may communicate with more than one fuel site, including fuel sites located remotely from the store.

Each fuel site point-of-sale computer system 12 may be linked to the pump controller of each fuel pump for communicating therewith regarding fuel transaction. Each fuel pump may also include a scanner (e.g., bar code scanner), magnetic card reader and/or other customer entry device (e.g., keypad) for customer entry of information. Any one of these devices can be used for the purpose of identifying the customer at the pump. The customer identification information is then transferred from the fuel site point-of-sale computer system 12 to the store point-of-sale computer system 10, which in turn communicates with a server 14. The server 14 may include an associated enterprise level database that stores customer information such as club point totals and club point transaction data, as will be described in further detail below. The server 14 is connected for communication with a server 16 that has an associated division level database of customer information. The server 16 communicates with a third party reward processing system 18 (KPS) that communicates with a third party server, such as a mobile device service provider server 20. The MSP server 20 has an associated customer account database for tracking customer mobile device usage and charges, as well as customer club points, as will be described in greater detail below. The MPS server 20 is capable of communicating with mobile wireless devices 22 of multiple customers, and customers can access their mobile account information via the web through customer computers 24. Customers can also manage their accounts by communicating with an MSP call center 26 that has access to the MSP server.

Mobile devices 22 intended for use in the customer reward system of the invention may typically be sold or otherwise obtained on site at the retail stores of the store entity. Though a customer obtains a phone or other mobile device at the store of the store entity, the mobile device service is provided through an arrangement between the customer and the MSP entity. The mobile device customer may enroll in the reward program in a number of ways. For example, the MSP server may send to the customer's mobile device (e.g., as a text, voice mail or email) a message inviting the customer to enroll in the reward system. Alternatively, this invitation may be integrated into an automated wireless device account set-up process that is initiated through the customer's mobile device in order to activate the device for service. In one case the customer may utilize the mobile device itself (e.g., through use of an IVR process with the MSP server) to provide the MSP server 20 with the information needed for enrollment (e.g., typically the customer's shopper card number). The MSP server also captures the mobile dialing number (MDN) and the enrollment date, all of which can be stored in the database(s) associated with the MSP server 20. Alternatively, the customer may call the MSP call center 26 to enroll or enroll via the MSP web site using a computer 24.

The MSP entity may permit multiple shopper card numbers to be linked to a single MDN account, enabling multiple households to contribute to rewards earned for the single MDN account. In this regard, while each household may earn its own distinct store entity provided rewards in the system of the present invention, the MSP entity rewards of the multiple households may be grouped together for a single MDN account.

Once the MSP entity has enrolled a customer in the reward program, the MSP entity must provide the store entity with data enabling the store entity to initiate the reward program for the customer. In this regard, the MSP sever 20 sends the KPS 18 the shopper card number, the MDN number and the enrollment date of the customer. The MDN number and the enrollment date are then linked to the customer's record in the databases of the servers 16 and 14. The customer records may also include fields identifying (i) customer name, (ii) points programs in which the customer participates, (iii) the total number of points earned toward each program, (iv) timestamp, store number, lane number and points for each point transaction (could be positive or negative points), (v) history of coupon redemption and coupon amounts, (vi) store employee flag (Y or N), (vii) targeted messages (e.g., for printing on the customer receipt in the store), (viii) processing status, (ix) shopper card status and (x) coupon numbers for each point program.

Once the store entity KPS 18 receives the enrollment information, the KPS may run an initial reward process, through communication with the servers 16 and 14, to communicate point transaction data to the MSP server 20 by identifying all point transactions for the customer that have occurred on or after the enrollment date. The point transaction data is written to a file along with the customer's MDN number and employee flag status and the file is then transferred to the MSP server 20 for handling pursuant to the MSP server reward rules.

In one embodiment, the store entity operates a fuel discount reward system in which customer's earn points based upon in-store purchases and the points can be redeemed for fuel discounts when the customer purchases fuel at one or more specific fuel sites. The fuel reward program may reward points on a 1 point per $1 purchase amount basis for all items purchased from a defined “bucket” of items (e.g., which may typically be all items with the exception of certain items, such as alcohol and tobacco, that by law may not be included in such a program). Points can also be earned in the store by, for example, filling a prescription in the store pharmacy (e.g., a defined number of points for each prescription filled) or for purchasing gift cards in the store (e.g., 1 point for every $1 worth of gift card value or 2 points for every $1 worth of gift card value). The store point-of-sale computer system 10 identifies the purchasing customer, tracks items purchased during a checkout transaction, identifies the fuel point total to be provided to the customer based upon the transaction and may communicate the fuel point total to the customer via a printed message on the customer receipt. The fuel point total and the fuel point transaction data, along with customer identification, are then communicated to the server 14. The server 14 in turn updates the fuel point total in the customer's database data, and incorporates the transaction record into the customer database as well.

At this point, the customer's fuel point total has been updated and the fuel points are available for customer redemption in the event of a fuel transaction. In this regard, when a customer shows up at a fuel site he/she provides customer identity (e.g., by scanning customer card or entering an ID number) and the fuel site point-of-sale computer system 12 communicates the customer identity to the store point-of-sale computer system 10, which in turn retrieves customer fuel point total from the server 14. The store point-of-sale computer system 10 may then use the fuel point total, alone or in combination with other information, to determine a fuel discount reward (e.g., a price-per-gallon discount, such as ten cents per gallon for 100 redeemed points, 20 cents per gallon for 200 redeemed points etc.) that is communicated to the fuel site point-of-sale computer system 12 in order to provide the reward to the customer at the pump (e.g. by rolling back the price-per-gallon at which gas is dispensed). Alternatively, the store point-of-sale computer system 10 may communicate the customer's fuel point total to the fuel site point-of-sale computer system 12, which then uses the fuel point total, alone or in combination with other information, to determine the fuel discount reward that will be provided to the customer at the pump. In a typical implementation of the fuel reward system customer fuel points are only available for redemption for a limited period of time (e.g., fuel points earned in a given month are only made available for customer redemption during the given month and the immediately following month). Any customer redemption of fuel points results in a reduction of the customer's fuel point total in the customer database associated with server 14 (e.g., the fuel points can only be redeemed once). In a preferred implementation a customer is not entitled to redeem fuel points for a fuel reward unless and until the total number of fuel points for the customer in a given month reaches a set level (e.g., 100 points).

In order to facilitate the provision of the MSP entity reward, the KPS 18 periodically (e.g., every 5, 10 or 15 minutes) runs a reward process to check the enterprise database associated with server 14 for any new fuel point transactions (i.e., fuel point transactions that have not previously been communicated to the MSP server 20). The point transaction data is written to a file along with the customer's MDN number and employee flag status and the file is then transferred to the MSP server for handling pursuant to the MSP server reward rules.

The MSP server 20 analyzes the point transaction data by identifying point transactions for each customer and updating the customer's account database record point total based upon the point transaction data. Each time the customer's point total reaches a set threshold, a mobile device reward is automatically provided to the customer. Specifically, the mobile device reward may be a defined amount of mobile phone usage time (e.g., 20 minutes for every 100 points for a non-employee or 30 minutes for every 100 points for a store entity employee) or a defined mobile phone service fee reduction (e.g., $1 reduction for every 100 minutes for a non-employee or $1.50 reduction for every 100 minutes for a store entity employee).

The selection of the reward type is triggered by the type of mobile device plan in which the customer is enrolled. If the customer has a limited usage type plan (e.g., pay as you go or defined number of permitted minutes), the MSP server 20 provides the reward to the customer as a defined amount of mobile phone usage time. Alternatively, if the customer has an unlimited usage type plan (e.g., unlimited monthly phone and/or data minutes) the MSP server 20 provides the reward to the customer as a defined mobile phone service fee reduction. In either case, the MSP server 20 initiates a timely message (e.g. text message, e-mail or voice message) to the customer's mobile device 22 to advise the customer that he/she has received the mobile device reward and automatically updates the customer's account record to reflect the reward. Preferably, the MSP system is implemented so that the customer message is triggered within a short duration (e.g. 1 hour or less) of when the MSP server 20 receives point data that brings a customer to the set point threshold.

In a preferred implementation the MSP server 20 permits points to accumulate indefinitely toward the mobile device reward (i.e., points earned in one month are not removed or wiped out after any set period (unless used to provide an MSP reward), as distinguished over the case of the use of points for fuel rewards). Therefore, a customer might earn 30 points in January, 20 points in February, 40 points in March, 0 points in April and 10 points in May, and all of those points are counted toward a mobile device reward that is triggered when the point total reaches 100 in May.

The above reward system enables a customer to receive both a store entity fuel discount reward and a MSP entity mobile device reward based upon points earned by purchasing items from the store entity (e.g., purchase of items from the defined store “bucket” of items earns points that are later used to award both a fuel reward and a mobile device reward, where the use of points to award of either a fuel reward or a mobile device reward does not impact the availability of those points for use in awarding the other reward type).

It is to be clearly understood that the above description is intended by way of illustration and example only and is not intended to be taken by way of limitation, and that changes and modifications are possible.

What is claimed is:

1. A method for providing retail customers with multiple reward types based upon in-store purchases, the method comprising:
monitoring customer in-store purchases utilizing an in-store point-of-sale computer system and awarding customer points based upon such in-store purchases;
storing both (i) cumulative customer point data and (ii) customer point transaction data in a customer database, the customer point transaction data including transaction date and time data;
accessing the cumulative customer point data to determine a first customer reward applicable to purchase of a specific product, the first customer reward triggered by identification of the customer's intent to purchase the specific product;
periodically transferring new customer point transaction data to a third party computer system for use by the third party computer system in identifying a second customer reward applicable to use of a customer mobile phone, such that customer points earned by the customer for in-store purchases are used to define two distinct reward types for the customer.

2. The method of claim 1, wherein the first customer reward is a price-per-unit discount on fuel and the second customer reward is one of a defined amount of mobile phone usage time or a defined mobile phone service fee reduction.

3. The method of claim 2, wherein the second customer reward is the defined amount of mobile phone usage time, and the second customer reward is automatically awarded to the customer each time the third party computer system identifies that customer earned points reach a specified level.

4. The method of claim 3, wherein when the second customer reward is made a message is sent to the customer mobile phone advising of the reward and the defined amount of mobile phone usage time is automatically added to the customer's mobile phone account.

5. The method of claim 2, wherein the second customer reward is the defined mobile service fee reduction, and the second customer reward is automatically awarded to the customer each time the third party computer system identifies that customer earned points reach a specified level.

6. The method of claim 5, wherein when the second customer reward is made a message is sent to the customer mobile phone advising of the reward and the defined mobile service fee reduction is automatically credited to the customer's mobile phone account.

7. The method of claim 2 wherein:
the cumulative customer point data is tracked on a monthly basis and unused points expire after a set time period and are no longer available for use in providing the first customer reward;
points tracked by the third party computer system are allowed to accumulate indefinitely without expiration as to use in providing the second customer reward.

8. The method of claim 1 wherein, the third party computer system:
tracks point data for each customer based upon received new customer point transaction data;
identifies when point data for a given customer reaches a specified incremental point level and in response to the given customer reaching the specified incremental point level:
if the given customer has a first mobile plan type, the third party computer system provides the second reward to the given customer as a defined amount of mobile phone usage time;
if the given customer has a second mobile plan type, the third party computer system provides the second reward to the given customer as a defined mobile phone service fee reduction.

9. The method of claim 8 wherein the first mobile plan type is a limited usage type plan and the second mobile plan type is an unlimited usage type plan.

10. A method for providing retail customers with a mobile device reward based upon customer purchases made in one or more retail stores, the method comprising:
(a) receiving in a computer system customer transaction data indicative of points earned by a customer through purchasing activity in one or more retail stores;
(b) via the computer system, tracking customer point data for the customer, identifying when point data for the customer reaches a specified incremental point level and in response to point data for the customer reaching the specified incremental point level:
if the customer has a first mobile plan type, the computer system provides the second reward to the customer as a defined amount of mobile phone usage time;
if the customer has a second mobile plan type, the computer system provides the second reward to the customer as a defined mobile phone service fee reduction.

11. The method of claim 10 wherein the first mobile plan type is a limited usage type plan and the second mobile plan type is an unlimited usage type plan.

12. The method of claim 10 wherein steps (a) and (b) are carried out by a first entity, and the method further involves a second entity tracking customer transaction data in one or more stores of the second entity and transferring the customer transaction data to the first entity.

13. The method of claim 12 wherein the second entity tracks total points earned in order to provide the customer with a fuel reward.
